(19) United States
(12) Patent Application Publication
(10) Pub. No.: US 2021/0342194 A1
(43) Pub. Date: Nov. 4, 2021

(54) COMPUTER RESOURCE ALLOCATION BASED ON CATEGORIZING COMPUTING PROCESSES

(71) Applicant: Citrix Systems, Inc., Fort Lauderdale, FL (US)

(72) Inventor: Jun Zhang, Nanjing (CN)

(21) Appl. No.: 16/911,519

(22) Filed: Jun. 25, 2020

Related U.S. Application Data
(63) Continuation of application No. PCT/CN2020/087666, filed on Apr. 29, 2020.

(51) Int. Cl. G06F 9/50; G06F 16/28; G06N 20/00

(52) U.S. Cl. CPC G06F 9/5038; G06N 20/00; G06F 16/285

(57) ABSTRACT

Described embodiments provide systems, methods and computer implemented instructions for computer resource allocation based on categorizing computing processes. A server receives data about processes executable by a client device. The processes can be executable within one or more time intervals. The client device can be identifiable with a unique identifier. The server selects, based on the unique identifier, a classification and a set of inputs to use to determine one or more categories for the received data. The set of inputs include a type of an application accessible by the client device and information about usage of the application. The server analyzes the received data for a given time interval to determine a category based on the selected classification and the set of inputs. The server provides one or more micro applications to the client device based at least in part on the determined category.

### CROSS-REFERENCE TO RELATED APPLICATION

This application is a continuation of and claims priority to International Application No. PCT/CN2020/087666, titled “COMPUTER RESOURCE ALLOCATION BASED ON CATEGORIZING COMPUTING PROCESSES,” and filed on Apr. 29, 2020, the contents of all of which are hereby incorporated herein by reference in its entirety for all purposes.

### FIELD OF THE DISCLOSURE

This application generally relates to allocating computing resources based on categorizing computing processes. In particular, this technical solution can employ a multi-level, customizable classification to categorize computing processes, and then allocate computing resources such as micro-applications.

### BACKGROUND

Users of client devices can perform tasks using applications executed by the client devices. Users can provide information about the tasks performed using the applications to an administrator of an entity. The administrator of the entity can manage the users based on the information reported by the users.

### SUMMARY

This Summary is provided to introduce a selection of concepts in a simplified form that are further described below in the Detailed Description. This Summary is not intended to identify key features or essential features, nor is it intended to limit the scope of the claims included herewith.

This technical solution generally relates to allocating computing resources based on categorizing computing processes. In particular, this technical solution can employ a multi-level, customizable classification to categorize computing processes, and then allocate computing resources such as micro-applications. Due to various types of processes executed by a client device, and the large number of employees at a company or in a team, it can be challenging to determine which applications are being utilized in a client device, or what tasks are being performed via the applications. Further, it can be challenging to optimize application utilization without an accurate determination of current utilization, which can result in wasted processor, memory, or network bandwidth utilization. Thus, systems and methods of this technical solution provide an efficient and accurate multi-level classification of computing process, and computing resource allocation based on the categories determined by the multi-level classification.

At least one aspect of this technical solution is directed to a method. The method can be performed by a server including one more processors. The method can include the server receiving data about one or more processes executable by a client device. The one or more processes being executable within one or more time intervals, and the client device being identifiable with a unique identifier. The method can include the server selecting, based on the unique identifier, a classification and a set of inputs to use to determine one or more categories for the received data. The set of inputs can include a type of an application accessible by the client device and information about usage of the application. The method can include the server analyzing the received data for a given time interval to determine a category based on the selected classification and the set of inputs. The method can include the server providing one or more micro applications to the client device based at least in part on the determined category.

In some implementations, the method can include the server receiving the data from an agent executable on the client device. The data can include a screen capture.

The method can include the server receiving an indication from the client device that the category for the given time interval is accurate. The server can select the one or more micro applications to provide based on the indication.

The method can include the server identifying a confidence level of the determination of the category for the given time interval using the classification. The method can include the server requesting, based on a comparison between the confidence level and a threshold, input to confirm the category for the given time interval is accurate. The server can determine the confidence level based on an amount of data collected for the client device.

The method can include the server providing a request for input that indicates the category for the given time interval is accurate. The server can receive, responsive to the request, an indication that category determined for the given time interval via the machine learning model is accurate. The server can update the category based on the received indication.

In some implementations, the set of inputs can include the type of the application and a type of activity. The method can include the server determining a value for the type of the application as one of a source code version control system or a communication tool. The server can detect a value for the type of activity as one of coding or collaboration. The server can determine the category as one of product development or project development.

The method can include the server identifying an organizational entity based on the unique identifier of the client device. The server can retrieve a classification hierarchy established by the organizational entity. The classification hierarchy including a plurality of classifications, and at least one classification including a plurality of categories. The server can select, based on the unique identifier, the classification to use to analyze the received data from the plurality of classifications of the classification hierarchy.

The method can include the server aggregating categories for a second time interval determined for a plurality of unique identifiers indicative of a plurality of client devices. The server can adjust, based on the aggregated categories for the second time interval, resource allocation for a group of unique identifiers comprising the unique identifier to improve productivity.

The method can include the server identifying a classification hierarchy established by an organizational entity identifiable with the unique identifier. The classification hierarchy can include a plurality of classifications. At least one classification can include a plurality of categories. The classification hierarchy can include a first classification of types of applications executable on the client device, a second classification for action analysis, and a third classification for content analysis based on keywords in the received data. The server can identify the classification as the third classification. The server can select the set of inputs for action analysis and content analysis using the keywords. The server can parse the received data including a foreground graphical user interface of an application executable by the client device to identify the set of inputs used for the third classification.

At least one aspect of this technical solution is directed to a system. The system can include a server having one or more processors. The server can receive data about one or more processes executable by a client device. The one or more processes being executable within one or more time intervals, and the client device being identifiable with a unique identifier. The server can select, based on the unique identifier, a classification and a set of inputs to use to determine one or more categories for the received data. The set of inputs can include a type of an application accessible by the client device and information about usage of the application. The server can analyze the received data for a given time interval to determine a category based on the selected classification and the set of inputs. The server can provide one or more micro applications to the client device based at least in part on the determined category.

In some implementations, the server can receive the data from an agent executable on the client device. The data can include a screen capture.

The server can receive an indication from the client device that the category for the given time interval is accurate. The server can select the one or more micro applications to provide based on the indication.

The server can identify a confidence level of the determination of the category for the given time interval using the classification. The server can request, based on a comparison between the confidence level and a threshold, input to confirm the category for the given time interval is accurate. The server can determine the confidence level based on an amount of data collected for the client device.

The server can provide a request for input that indicates the category for the given time interval is accurate. The server can receive, responsive to the request, an indication that category determined for the given time interval via the machine learning model is accurate. The server can update the category based on the received indication.

In some implementations, the set of inputs can include the type of the application and a type of activity. The server can determine a value for the type of the application as one of a source code version control system or a communication tool. The server can detect a value for the type of activity as one of coding or collaboration. The server can determine the category as one of product development or project development.

The server can identify an organizational entity based on the unique identifier of the client device. The server can retrieve a classification hierarchy established by the organizational entity. The classification hierarchy including a plurality of classifications, and at least one classification including a plurality of categories. The server can select, based on the unique identifier, the classification to use to analyze the received data from the plurality of classifications of the classification hierarchy.

The server can aggregate categories for a second time interval determined for a plurality of unique identifiers indicative of a plurality of client devices. The server can adjust, based on the aggregated categories for the second time interval, resource allocation for a group of unique identifiers comprising the unique identifier to improve productivity.

The server can identify a classification hierarchy established by an organizational entity identifiable with the unique identifier. The classification hierarchy can include a plurality of classifications. At least one classification can include a plurality of categories. The classification hierarchy can include a first classification of types of applications executable on the client device, a second classification for action analysis, and a third classification for content analysis based on keywords in the received data. The server can identify the classification as the third classification. The server can select the set of inputs for action analysis and content analysis using the keywords. The server can parse the received data including a foreground graphical user interface of an application executable by the client device to identify the set of inputs used for the third classification.

At least one aspect of this technical solution is directed to a non-transitory computer readable medium storing program instructions. The program instructions can cause one or more processors to receive data about one or more processes executable by a client device. The one or more processes being executable within one or more time intervals, and the client device being identifiable with a unique identifier. The instructions can include instructions to select, based on the unique identifier, a classification and a set of inputs to use to determine one or more categories for the received data. The set of inputs can include a type of an application accessible by the client device and information about usage of the application. The instructions can include instructions to analyze the received data for a given time interval to determine a category based on the selected classification and the set of inputs. The instructions can include instructions to provide one or more micro applications to the client device based at least in part on the determined category.

### BRIEF DESCRIPTION OF THE DRAWINGS

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of embodiments of a computing device;

FIG. 1B is a block diagram depicting a computing environment comprising client device in communication with cloud service providers;

FIG. 2 depicts an example block diagram of a system to allocate computing resources, in accordance with an implementation.

FIG. 3 depicts an example flow diagram of a method for categorizing computing processes, in accordance with an implementation.

FIG. 4 depicts an example multi-level classification table illustrating categorization of computing processes, in accordance with an implementation;

FIG. 5A is a block diagram of an example system in which resource management services may manage and streamline access by clients to resource feeds (via one or more gateway services) and/or software-as-a-service (SaaS) applications;

FIG. 5B is a block diagram showing an example implementation of the system shown in FIG. 5A in which various resource management services as well as a gateway service are located within a cloud computing environment; and

FIG. 5C is a block diagram similar to that shown in FIG. 5B but in which the available resources are represented by a single box labeled “systems of record,” and further in which several different services are included among the resource management services.

### DETAILED DESCRIPTION

Following below are more detailed descriptions of various concepts related to, and implementations of, methods and systems for computer resource allocation based on categorizing computing processes. The various concepts introduced above and discussed in greater detail below may be implemented in any of numerous ways.

Due to various types of processes executed by a client device, and the large number of employees at a company or in a team, it can be challenging to determine which applications are being utilized in a client device, or what tasks are being performed via the applications. For example, it can be technically challenging to determine the level or type of resource utilization by employees as the types of available resources increases and the number of employees increase. Failure to accurately or reliably determine resource utilization can result in inefficient resource allocation, such as the allocation of micro-apps or other applications or computing resources. As such, it can be challenging to optimize application utilization without an accurate determination of current utilization, which can result in wasted processor, memory, or network bandwidth utilization. Thus, systems and methods of this technical solution provide an efficient and accurate multi-level classification of computing process, and computing resource allocation based on the categories determined by the multi-level classification.

The systems and method of the present technical solution can provide for computer resource allocation based on categorizing computing processes. For example, team members, such as engineers, may submit a productivity report using a productivity tool every month (or some other time interval). A productivity report can be a working efficiency tool that summarize how much time is invested by the engineer. The productivity report can include categories and products, and summarize how much time the engineer invests in each category and each product. However, it may be time-consuming and inaccurate for an engineer to estimate how much time they spent on each category and each product because various application can be utilized in a given client device to perform various tasks at disparate times. Thus, the productivity report used to determine human resource investment may be unreliable and result in increases in operational and infrastructure costs of an organization or entity caused by erroneous resource allocation.

Systems and methods of this technical solution can automatically determine resource investment by an engineer by analyzing the user's behaviors and job actions. The system can then calculate the user's resource/time allocation in each job category. This technical solution can be combined with micro-apps or other types of applications as a plug-in.

For example, at a software company, an engineer's job responsibility can include: 1) documentation, 2) coding, 3) collaboration, 4) meeting, 5) training, 6) paid time off (“PTO”), and 7) travel. The various systems, tools or applications an engineer may use to perform these job responsibilities can include, for example: 1) a source code version control system or management system (e.g., Git, Concurrent Versions Systems “CVS”, Apache Subversion “SVN”, Mercurial, or Monotone); 2) documentation system (e.g., Confluence, Bynder, FileHold, Agiloft, or Wiki); 3) browser system (e.g., Firefox, Chrome, Safari, or Edge); 4) office software for word processing, spreadsheets, or presentations (e.g., Microsoft Office, Notepad++, or WPS Office); 5) communication tools (e.g., Lync, Slack, What's App, or WeChat); 6) financial and management systems (e.g., Workday, Concur, or SAP).

This technical solution can monitor the above activities, analyze the activity, and then categorize the activities into categories. The categories can be pre-determined and be referred to as productivity groups. For example, categories at a software company can include: 1) Product development; 2) collaboration effort; 3) self-development; or others (e.g., PTO, travel).

To monitor a user's client device, a system of this technical solution can include an agent that runs as a daemon job on a computing device (e.g., laptop, workstation, or mobile device). The system can analyze the user's job activities through monitoring the applications or engineering tools being used, and then tag or categorize them into categories or productivity groups. The system can use a machine learning engine or model, or other classifier, to analyze data associated with the user's job activities to tag or categorize the job activities. During a learning phase of the classifier (e.g., the first week), the system can ask the user to confirm or validate whether the automatic categorization is accurate. After the learning phase is complete (e.g., after 1 week), the system can record activities silently (e.g., without providing a prompt to the user). The system can adjust, fix, revise, or tune the categorization on a monthly (or other extended duration) after the learning phase is complete. The system can use the categorization to select a micro application to provide to the client device, which can improve productivity or performance associated with the client device.

Thus, this technical solution can facilitate the automatic determination of resource utilization of engineers, facilitate planning and resource adjustment, facilitate return on investment analysis or competency analysis, facilitate human resource shifting or optimization on talent building and career development, or facilitate selecting and providing micro-apps to users.

For example, it can be technically challenging to determine the level or type of resource utilization by employees as the types of available resources increases and the number of employees increase. Further, failure to accurately or reliably determine resource utilization can result in inefficient resource allocation, such as the allocation of micro-apps or other applications or computing resources. Thus, systems and methods of this technical solution can improve the reliability and accuracy with which resource utilization can be determined in an efficient manner, as well as optimize computing resource allocation. For example, by providing different levels of customizable classification, this technical solution can optimize the desired level of classification for both precision and accuracy, as well as computing efficiency. Further, based on the results of the classification, this technical solution can facilitate resource allocation or adjustment. The technical solution can be integrated into a micro-application workspace or computing environment, such as an individual SaaS app, a plug-in of a workspace, or a standalone daemon running in the backend on a workspace or laptop (e.g., published through a group policy or batch command).

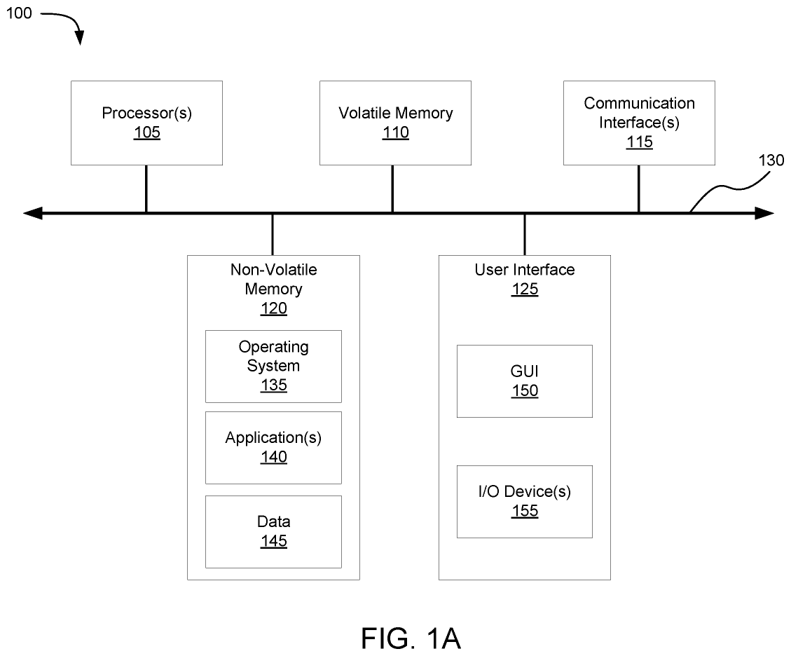

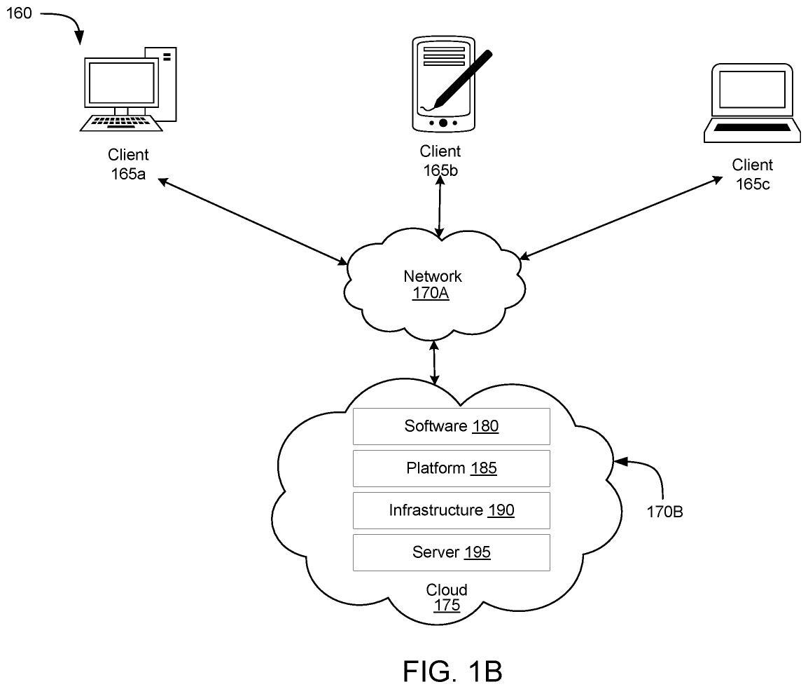

Prior to discussing the specifics of embodiments of the systems and methods of an appliance and/or client, it may be helpful to discuss the computing environments in which such embodiments may be deployed. As shown in FIG. 1A, computer 100 may include one or more processors 105, volatile memory 110 (e.g., random access memory (RAM)), non-volatile memory 120 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 125, one or more communications interfaces 115, and communication bus 130. User interface 125 may include graphical user interface (GUI) 150 (e.g., a touchscreen, a display, etc.) and one or more input/output (I/O) devices 155 (e.g., a mouse, a keyboard, a microphone, one or more speakers, one or more cameras, one or more biometric scanners, one or more environmental sensors, one or more accelerometers, etc.). Non-volatile memory 120 stores operating system 135, one or more applications 140, and data 145 such that, for example, computer instructions of operating system 135 and/or applications 140 are executed by processor(s) 105 out of volatile memory 110. In some embodiments, volatile memory 110 may include one or more types of RAM and/or a cache memory that may offer a faster response time than a main memory. Data may be entered using an input device of GUI 150 or received from I/O device(s) 155. Various elements of computer 100 may communicate via one or more communication buses, shown as communication bus 130.

Computer 100 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 105 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 115 may include one or more interfaces to enable computer 100 to access a computer network such as a Local Area Network (LAN), a Wide Area Network (WAN), a Personal Area Network (PAN), or the Internet through a variety of wired and/or wireless or cellular connections.

In described embodiments, the computing device 100 may execute an application on behalf of a user of a client computing device. For example, the computing device 100 may execute a virtual machine, which provides an execution session within which applications execute on behalf of a user or a client computing device, such as a hosted desktop session. The computing device 100 may also execute a terminal services session to provide a hosted desktop environment. The computing device 100 may provide access to a computing environment including one or more of: one or more applications, one or more desktop applications, and one or more desktop sessions in which one or more applications may execute.

Referring to FIG. 1B, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers 195, processing, memory, storage, applications, virtual machines, databases, software, hardware, analytics, and intelligence.

In embodiments, the computing environment 160 may provide client 165 with one or more resources provided by a network environment. The computing environment 160 may include one or more clients 165a-165n, in communication with a cloud 175 over one or more networks 170A, 170B. Clients 165 may include, e.g., thick clients, thin clients, and zero clients. The cloud 175 may include back end platforms, e.g., servers 195, storage, server farms or data centers. The clients 165 can be the same as or substantially similar to computer 100 of FIG. 1A.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 175 may be public, private, or hybrid. Public clouds 175 may include public servers 195 that are maintained by third parties to the clients 165 or the owners of the clients 165. The servers 195 may be located off-site in remote geographical locations as disclosed above or otherwise. Public clouds 175 may be connected to the servers 195 over a public network 170A. Private clouds 175 may include private servers 195 that are physically maintained by clients 165 or owners of clients 165. Private clouds 175 may be connected to the servers 195 over a private network 170B. Hybrid clouds 175 may include both the private and public networks 170A, 170B and servers 195.

The cloud 175 may include back end platforms, e.g., servers 195, storage, server farms or data centers. For example, the cloud 175 can include or correspond to a server 195 or system remote from one or more clients 165 to provide third party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 165. The computing environment 160 can provide an elasticity to dynamically scale out or scale in responsive to different demands from one or more clients 165. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include server-less computing. The computing environment 160 can include Software as a service (SaaS). For example, the cloud 175 may also include a cloud based delivery, e.g. Software as a Service (SaaS) 180, Platform as a Service (PaaS) 185, and Infrastructure as a Service (IaaS) 190. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 165 may also access SaaS resources through smartphone or tablet applications, including, e.g., Salesforce Sales Cloud, or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

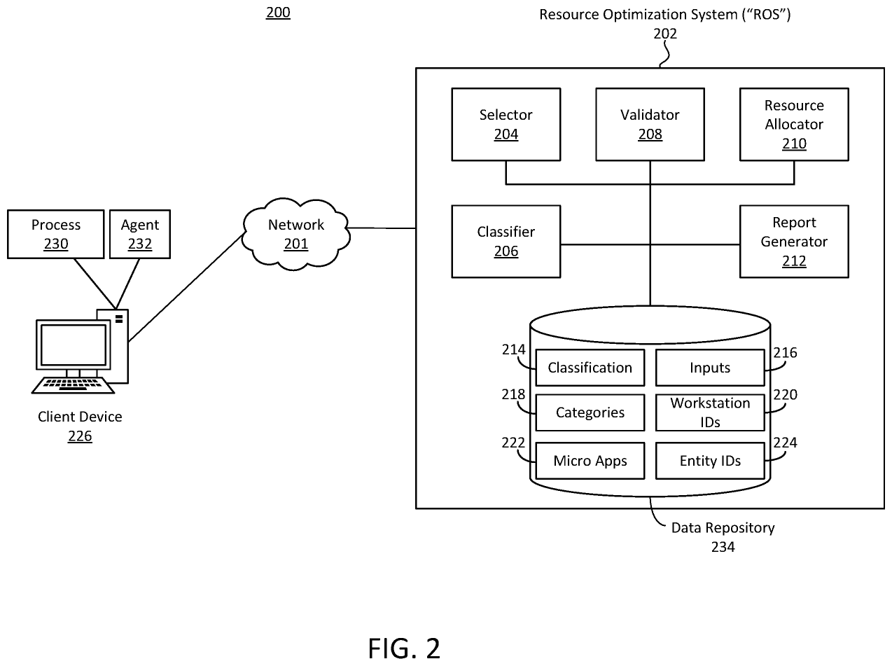

FIG. 2 depicts an example block diagram of a system to allocate computing resources, in accordance with an implementation. In brief overview, the system 200 can include a resource optimization system (“ROS”) 202. The ROS 202 can include at least one selector 204. The ROS 202 can include at least one classifier 206. The ROS 202 can include at least one validator 208. The ROS 202 can include at least resource allocator 210. The ROS 202 can include at least report generator 212. The ROS 202 can include at one data repository 234. The data repository 234 can include or store one or more of a classification 214, inputs 216, categories 218, workstation identifier (“IDs”) 220, micro apps 222, or entity IDs 224. Each of the selector 204, classifier 206, validator 208, resource allocator 210, or report generator 212 can include one or processing circuit, module, component, digital logic, scripts, rules, programs or components or functionality depicted in FIGS. 1A and 1B.

The ROS 202 can interface with a client device 226 via network 201. The client device 226 can provide a native (e.g., access to local applications) or virtual computing environments (e.g., access to a virtual desktop hosted by a server in a cloud 175). The client device 226 can execute one or more processes 230 (e.g., applications or tools such as an electronic mail (“e-mail”) program (e.g., Outlook), a word processing program, a software version control program, presentation program, spreadsheet program, calendar program, video conference program, asynchronous communication program, etc.). The client device 226 can execute one or more agents 232 that can obtain data about processes 230 executed by the client device 226.

The network 201 may be any type or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wire line network. The network 201 can include one or more of network 170A or network 170B depicted in FIG. 1B.

The ROS 202 can be at least one logic device such as a computing device having a processor to communicate via the network 201, for example, with the client device 226. The ROS 202 can include at least one computation resource, server, processor or memory. For example, the ROS 202 can include multiple computation resources or servers located in at least one data center. The ROS 202 can include multiple, logically-grouped servers and facilitate distributed computing techniques. The ROS 202 can include or execute in a cloud 175. The ROS 202 can include one or more servers 195. The ROS 202 can communicate via network 201 with client device 226. The client device 226 can include one or more of component or functionality of client 165a-c. The client device 226 can include a client 165a, 165b, or 165c.

Still referring to FIG. 2, and in further detail, the ROS 202 can include a selector 204 designed, configured and operational to select a classification to use to categorize a process. A classification can include a rule, policy, or technique used to analyze a process executed on a client device. The classification can refer to a type of analysis to perform using the data received about the process. The ROS 202 is configured with different types of classifications, and the selector 204 can select one of the classification to use to analyze the data about a process. For example, the selector 204 can receive data about one or more processes (e.g., processes 230) that are being executed by the client device 226 during one or more time intervals. The selector 204 can select, based on an identifier (e.g., a unique identifier) of the client device 226, a classification and a set of inputs to use to determine one or more categories for the received data. The category can be an output of the classification. The ROS 202 analyzes the received data using the selected classification to determine a category of the received data. For example, the set of inputs can include a name or identifier of an application being executed by the client device and information about usage of the application. A name or identifier of an application can include, for example, “E-Mail Program”. Usage of the application can include, for example, time stamps for when the graphical user interface of the application is in a foreground state or active state on a client device of the user, and a state of the application such as reading or composing an electronic message. The set of inputs can be processed using a classification, which can entail determining the type of application, the activity being performed in the application and then determining a category for the process based on the activity and type of application. For example, the type of application can be an electronic communication application and the activity can be read/write email, which can map to the category “collaboration.”

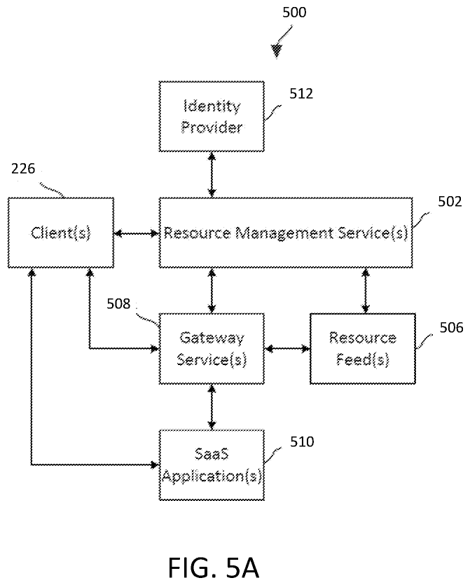

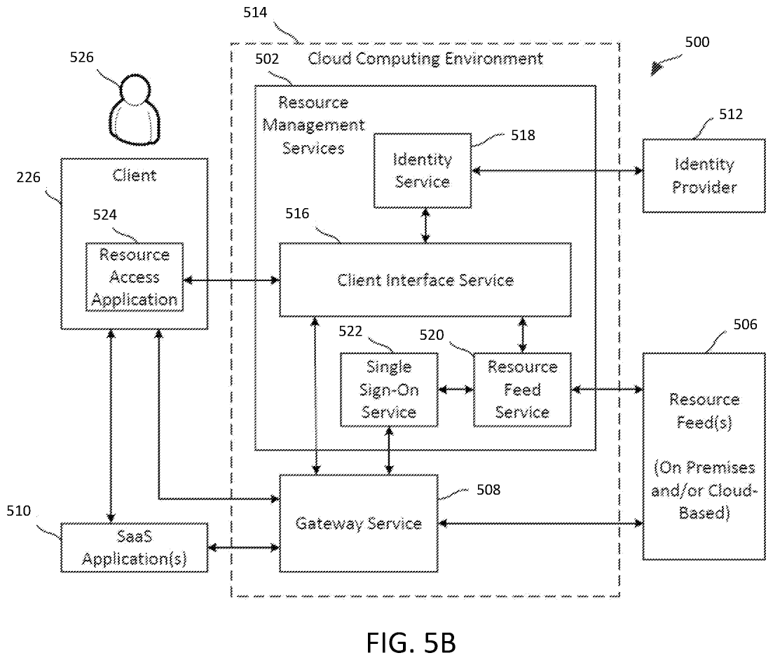

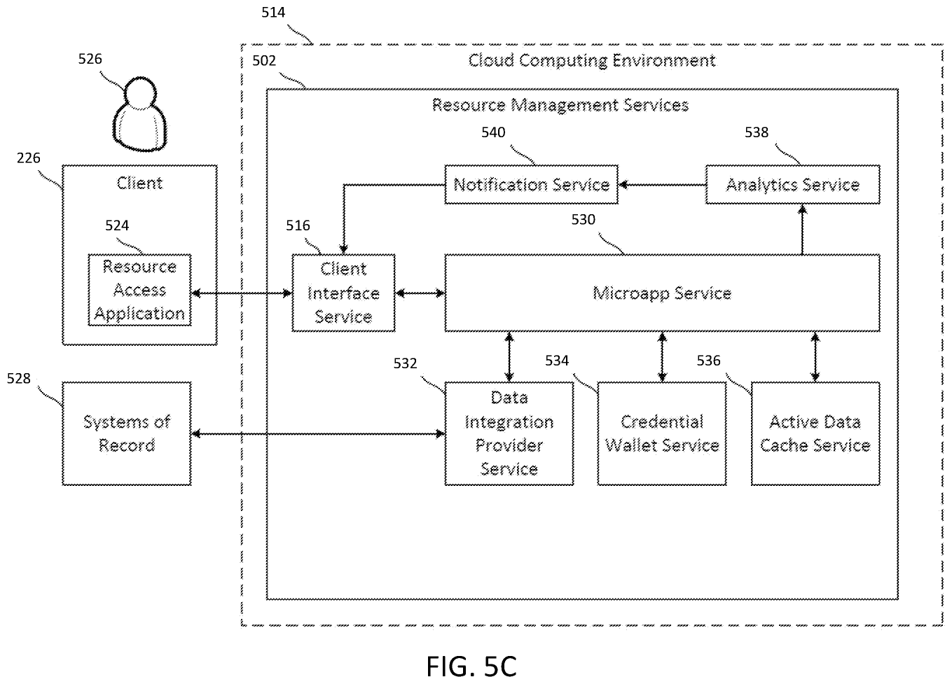

The selector 204 can receive data from the client device 226 about processes 230 executed in a native or virtual computing environment by the client device 226. The client device 226 can provide a virtual computing environment hosted by a cloud 175. The processes 230 can include one or more SaaS or other web applications 510 or resource feeds 506 provided via a cloud computing environment 514 depicted in FIG. 5A, 5B, or 5C. The data can be received based on an event, time interval, periodically, responsive to a request for data, based on a state of the client device 226, responsive to user login, or based on some other condition or trigger.

The selector 204 can receive data from an agent 232 executing on the client device 226. The agent 232 can be a software program executable on a client device 226 that receives input or instructions from the ROS 202, and provides output to the ROS 202. The agent 232 can include a script, daemon, monitor, or other program that can capture data of processes 230 executable on the client device 226. The agent 232 can include one or more component or functionality of a task manager program of an operating system for the client device 226. The agent 232 can perform a screen capture, or otherwise capture information of processes that are executing in the client device 226. For example, the agent 232 can leverage a task manager program of the client device 226 to identify processes that are executing on the client device 226. The agent 232 can include an individual SaaS application, such as a SaaS application 510 depicted in FIGS. 5A and 5B. The agent 232 can be a plug-in to a client device 226. The agent 232 can be a daemon running in the backend in the client device 226 or client device 226.

The agent 232 can determine whether the processes are executing in foreground process or a background process. The agent 232 can determine whether a process is being actively used by a user of the client device 226, or is in standby state. The agent 232 can call a task manager or activity manager running on the client device 226. For example, an operating system executing on the client device 226 can include a task manager component that indicates what processes 230 are running or executing on the client device 226. The agent 232 can use a function or call such as “GetForegroundWindow” which can return the top-level parent window for a process 230 executing in the client device 226. The agent 232 can determine whether the application is active or in the foreground using a function call such as “GetWindowThreadProcessId.” If the agent 232 has an identifier for the process 230, the agent can execute a call or function such as “IsForegroundProcess (process identifier)” where the input to the function is the identifier for the process 230. The agent 232 can obtain additional usage information about the process 230 using one or more calls, functions, or operating system components.

The agent 232 can determine the amount of computing resource being used by a process, such as a processor utilization level, memory utilization level, disk read/write utilization, or network bandwidth utilization. The agent 232 can perform a function call to the task manager component of the operating system to determine the amount of computing resources being used by the process 230. The agent 232 can obtain a screen capture of a graphical user interface associated with the application. The client device 226, or operating system executing on the client device 226, can include screenshot support, such as a built-in or native screenshot function. The agent 232 can invoke the native screenshot functionality of the client device 226 to obtain the screenshot. The screenshot can be a digital image or a raster image (e.g., raster graphics or bitmap image that includes a dot matrix data structure).

The agent 232 can obtain data of the client device 226 at various time intervals, or responsive to various conditions, triggers or events. The agent 232 can be configured to obtain data in a manner that reduces processor, memory, and network bandwidth utilization. The agent 232 can be configured to obtain data in a manner that reduces computing resource utilization so as to prevent or mitigate latencies associated with the processes being used by the user of the client device. For example, the agent 232 can capture or obtain data about processes 230 executed by the client device 226 based on a time interval, such as every 30 seconds, 60 seconds, 2 minutes, 3 minutes, 5 minutes, 7 minutes, 10 minutes, 15 minutes or other time interval. In some cases, the agent 232 can obtain data about processes 230 responsive to a trigger, such as when a process 230 is launched, maximized, minimized, or terminated. The agent 232 can obtain data about a process 230 responsive to receiving a request for data from the ROS 202 via network 201. The agent 232 can obtain data about one or more processes 230 responsive to a request for data from a user of the client device 226. The agent 232 can obtain data about one or more processes responsive to the process 230 going from a background process to a foreground process, or responsive to a state change in the process. The agent 232 can obtain data based on a condition, such as a type of process 230 (e.g., launch of an email program or word processing program). Thus, the agent 232 can obtain data about a process 230 based on a time interval or other trigger, event or condition.

The agent 232 can provide the data to the ROS 202. The ROS 202 can receive the data from the agent 232. The agent 232 can provide the data to the ROS 202 in real-time (e.g., responsive to the agent 232 obtaining the data), or based on a time interval, condition, trigger or event. The agent 232 can provide the data to the ROS 202 based on a time interval such as hourly, every 2 hours, every 3 hours, every 4 hours, every 6 hours, every 12 hours, every 24 hours, every 48 hours, every 72 hours, weekly, every 2 weeks, monthly or some other time interval. The agent 232 can provide the data to the ROS 202 during a batch upload. The agent 232 can provide the data to the ROS 202 based on the amount of stored data satisfying a threshold or condition. For example, the agent 232 can provide the data to the ROS 202 after a predetermined number of data entries (e.g., 100 entries, 200 entries, 500 entries, 1000 entries) have been stored, or the size of the data equals or exceeds a predetermined data size (e.g., 1 megabyte, 5 megabytes, 20 megabytes, or 50 megabytes). The agent 232 can provide the data to the ROS 202 during or responsive to a client device 226 log-off process, such as responsive to the user logging out of or restarting the client device 226. The agent 232 can provide the previously stored data responsive to the client device booting up or launching.

The agent 232 can transmit the data captured about the processes 230 executed in the client device 226 to ROS 202 via network 201 using one or more formats. For example, the agent 232 can compress the captured data or encrypt the captured data prior to the transmission. The agent 232 can de-duplicate the captured data or aggregate the captured data to reduce the file size while maintaining the accuracy or level of detail of the data. For example, the agent 232 can identify multiple consecutive entries for the execution of a process 230, and consolidate the multiple entries into a single entry with an associated time interval that includes a start time and a stop time. In some cases, the agent 232 can further consolidate non-consecutive entries for a process 230 by providing multiple time intervals for the execution of the process 230. For example, if the process 230 occurred from 9 to 9:30, 11 to 11:30, and 2 to 2:30, then the agent 232 can generate a single data structure for process 230 as follows {Process ID, 9 to 9:30; 11 to 11:30; 2 to 2:30}, instead of creating three different data structures as follows {Process ID, 9 to 9:30}, {Process ID, 11 to 11:30}, and {Process ID, 2 to 2:30}.

The agent 232 can pre-process or filter the captured data. The agent 232 can apply a security protocol or whitelist protocol to filter or scrub the data prior to transmission. For example, the agent 232 can remove data of processes 230 that are not authorized for transmission to the ROS 202 to ensure that only information about processes 230 that are whitelisted are transmitted to the ROS 202. The whitelist information can be stored in a configuration file in memory of the client device 226, or in a data repository 234 stored in the ROS 202 and accessed by the agent 232. In some cases, the ROS 202 can obtain the data and filter the data to remove unauthorized information.

In some cases, the processes that are analyzed can be whitelisted in order to provide privacy. For example, an entity, company or user can authorize the system to analyze processes, actions or content associated with particular applications or processes, such as an e-mail program or word processing program. For unauthorized applications, such as, for example, a streaming video program, the system can categorize the process as “other” to protect privacy, and may not perform any classification or minimal classification (e.g., only perform level one classification in order to determine the process is to be identified as other). In another example, the agent 232 or ROS 202 can be configured to identify only pre-defined or predetermined terms in an e-mail. For example, the employer can provide a predefined list of product names, and the agent 232 or ROS 202 can search for those product names in the content of an e-mail. If none of those product names exist in the e-mail, then the ROS 202 can skip content analysis for that e-mail. In another example, the ROS 202 can be configured to only parse content of e-mails that are being sent to an e-mail address corresponding to a domain of the company or other whitelisted domain. The user or the employer can control or customize the whitelist using a configuration file. For example, the configuration file can be:
YAML (or XML, format):
File: Analysis Configuration
Date: 2020 Mar. 1
Customer:
   Given: John
   Family: Doe
Productivity Tool:
   Group: Product A
   Processes: Outlook
   Action: /
   Content: A, AA, AAA, CVAD, XA, XD, XAD, AA, DD

In the above example configuration file, the analysis can include keyword matching schema, or be based on machine learning.

The agent 232 can transmit data captured about processes 230 executing in the client device 226 along with additional information that can facilitate analysis of the processes. The agent 232 can transmit the information using any format or data structures. The agent 232 can generate logs or records of the information that can include timestamps, process identifiers, application names, application user interfaces identification, application state information, input/output associated with the application, content (e.g., text, terms, keywords, phrases, images, audio, or video) being input or output via a user interface of the process 130 or application, and a unique identifier associated with a user of the client device 226 (or process 230 or client device 226). In some cases, the data provided by the agent 232 can include a screen capture, such as a bitmap representation of a graphical user interface of the client device 226 or a specific process 230 executed in the client device.

The unique identifier associated with the user can include, for example, an employer provided identifier, or other identifier that identifies a user of the client device 226. The unique identifier can be referred to as a workstation ID 220 and stored in data repository 234 of ROS 202. The workstation ID 220 can be mapped or associated with an entity ID 224, which can be stored in data repository 234 of the ROS 202. The entity ID can refer to or include an identifier for a company or organization that provides or administers the client device 226, or otherwise manages the user. Thus, the workstation ID 220 data structure can include or indicate an association, link or reference between a workstation ID and a corresponding entity ID. The ROS 202 can perform a lookup in the workstation ID 220 data structure using a workstation ID to determine a corresponding entity ID stored in the entity ID 224 data structure. Similarly, the ROS 202 can perform a lookup in the entity ID 224 data structure using an entity ID to identify, determine or retrieve a corresponding one or more workstation IDs stored in the workstation ID 220 data structure. The identifiers used for the workstation or entity can include alphanumeric characters, such as letters and numbers, or any other character or symbols.

The selector 204, upon receiving the data from the agent 232, can select a classification to use to analyze the data. The selector 204 can select a classification from the classification data structure 214 stored in data repository 234. The classification data structure 214 can include or store multiple different classifications. The different classifications can correspond to different levels of classification or different types of classifications. The different types or levels of classifications can use different sets of inputs, or the same sets of inputs. The different types or levels of classifications can use the same or different analysis techniques, rules, logic, or classifiers. The different types or levels of classifications can provide the same output or different output categories. Thus, the different levels of classifications can be similar in some aspects, and different in other aspects.

For example, applying a level one classification, the ROS 202 can categorize a user's activity based on the type of application executed in the client device 226. In a level two classification, the ROS 202 can categorize the activity based on the type of application and additional information about the state of the application, such as information of the user interface of the application or input/output of the application. In a level three classification, the ROS 202 can categorize the activity based on keywords input or output via a user interface of the application, in addition to the information used by the level one and level two classifications. Thus, in this example, subsequent levels in the hierarchy of levels of classifications can use all or some of the inputs of the previous level in addition to a new input. Further, the levels of classification can use a more granular or detailed analysis techniques. For example, level one classification can use an index that maps application types to output categories. Level two classification can use an index that is more detailed than the index of level one by additionally mapping application state information to output categories. Level three classification, for example, can use keyword matching for an application type to determine an output category. The keyword matching technique can be specific to the application type, or general across different application types. The output categories for level three classification can be more granular than the output categories for level one or level two classification. For example, the output category for level one classification can be collaboration or product development, whereas the output category for level three classification can further specify the particular phase of the project, such as research and development, quality assurance, or customer support. Level four classification, for example, can utilize a machine learning model that has been trained based on historical data to categorize the received data.

The classifications 214 can be customized by an entity. The classification data structure 214 can be configured by an administrator of the entity. An administrator of an entity can establish their own set of classifications that use certain types of input, such as predefined keywords, and provide certain types of output, such as predetermined categories. An administrator of the entity can customize the level of classification to use for workstation IDs 220 associated with the entity ID 224. The entity can customize different levels of classifications to use for different workstation IDs 220 based on one or more factors. For example, the entity can specify which level of classification to use based on the role of the workstation ID (e.g., whether the user is a software engineer, manager, in human resources, legal department, sales, etc.), the time of day (e.g., during work hours, outside work hours, weekend, weekday, etc.), type of process 230 executed during the time interval, geographic location of the client device 226, type of client device 226 (e.g., mobile device, laptop device, desktop device, etc.), amount of process or memory utilization by the process 230, or any other factor.

The selector 204 can select a classification to use based on the workstation ID 220, which can be received from the agent 232. The selector 204 can select a classification to use from the classification data structure 214 based on the workstation ID 220 and a policy. The selector 204 can select the classification to use based on the configuration established by an entity associated with the workstation ID 220, or based on a configuration established by the workstation ID. The selector 204 can select the classification to use based on the available data received from the agent 232.

For example, the selector 204 can receive the workstation ID 220 from the agent 232 and perform a lookup in the workstation ID 220 data structure to determine a corresponding entity ID. The selector 204 can then perform a lookup in the entity ID 224 data structure to determine a classification established by the entity, or a classification policy. In the event the entity established a classification to use, the selector 204 can select the classification. In the event the entity established a classification policy to use to select a classification, the selector 204 can obtain the classification policy and apply the classification policy to select a classification (e.g., select level one classification if the workstation ID 220 corresponds to a user that is in the human resources department, or select a level three classification if the workstation ID 220 corresponds to a user that is a software developer, or select a level four classification if the workstation ID 220 corresponds to a user that is a software developer on Project X). Thus, the selector 204 can select the classification to use based on one or more techniques or policies that can be default policies or customized by an entity.

Upon selecting a classification to use from classification data structure 214, the selector 204 can determine a set of inputs used to perform the selected classification. The ROS 202 can use the set of inputs for the selected classification to determine one or more categories for the received data. Information about the set of inputs used for a classification can be stored in the classification data structure 214, or in a corresponding inputs data structure 216. The inputs data structure 216 can include information about sets of inputs used for each classification. For example, for a level one classification, the set of inputs can include an application identifier or type of application, time stamps corresponding to execution of the application, and a workstation ID. An example set of inputs for a level two classification can include all of the inputs for level one classification, and a new set of inputs corresponding to a state of the application (e.g., composing an e-mail, reading an e-mail, or creating a calendar event). Example sets of inputs for a level three classification can include all of the inputs for a level two classification, and a new set of inputs that include keywords provided via a user interface of the application.

Additional examples of sets of inputs can include, for example, a type of an application, usage information associated with the application (e.g., state information, processor utilization, memory utilization, background or foreground execution, etc.). Usage information can include a type of activity associated with the application, input provided to the application via a user interface of the application (e.g., keyboard and mouse input, voice input, sensor input such as location information), output provided via a user interface of the application (e.g., visual output, audio output, text, keywords, phrases, images, or video). The ROS 202 can determine the type of application based on a process ID or application name, or the agent 232 can provide the type of applications. Example types of application can include source code version control system, document system, browser system, office software, communication tool, or a cloud-based management system. The ROS 202 can determine the type of activity from the received data, which can include documentation, coding, collaboration, meeting, training, paid time off, or travel.

Thus, the selector 204 can identify an organizational entity (e.g., entity ID 224) associated with the unique identifier of the client device (e.g., workstation ID 220). The selector 204 can retrieve a classification hierarchy (e.g., from classification 214 data structure) established by the organizational entity having the entity ID. The classification hierarchy stored in classification data structure 214 can include multiple classifications that each including multiple categories or are configured to categorize received data in one or more categories. The selector 204 can select, based on the unique identifier of the workstation, the classification to use to analyze the received data. For example, if the entity has indicated to use level one classification for all unique identifiers associated with the entity, then the selector 204 can use level one classification. In another example, if the entity has indicated to select the level of classification based on the role of the user, then the selector 204 can use the selection policy to determine the corresponding classification to use for the user based on the workstation ID.

As the different classifications can use different sets of inputs to perform different types of analysis, the ROS 202 can reduce computing resource utilization (e.g., processor and memory utilization) by selecting one classification relative to another in order to achieve the desired level of granularity, accuracy or confidence with a classification. For example, the selector 204 can select a less granular, and therefore less computationally resource intensive, classification for an entity that may not desire granular categories for processes 130 occurring a certain time period, at a certain geographic location, or for users in certain departments (e.g., human resources or sales departments). However, the selector 204 can select a more granular, and therefore more computationally resource intensive, classification for users in a software development department. Thus, by dynamically selecting classifications based on various factors or criteria (e.g., time periods, locations, or departments), the selector 204 can reduce overall computation resource utilization, while providing a desired level of granularity or resolution for the categorization.

The ROS 202 can include a classifier 206 designed, constructed and operational to analyze the received data for a given time interval to determine a category based on the selected classification and the set of inputs. The classifier 206 can process the data received from the agent 232 to identify values for the set of inputs that corresponds to the selected classification. The classifier 206 can input the values to the classification to determine a category. The received data can include data for one or more time intervals, and the classifier 206 can categorize the data for the one or more time intervals using the selected classification. In some cases, the classifier 206 can use different classifications to categorize the data for the different time intervals. For example, the classifier can use a level one classification to categorize data for a non-working-hours time interval, and use a level three classification to categorize data for a working hour time interval.

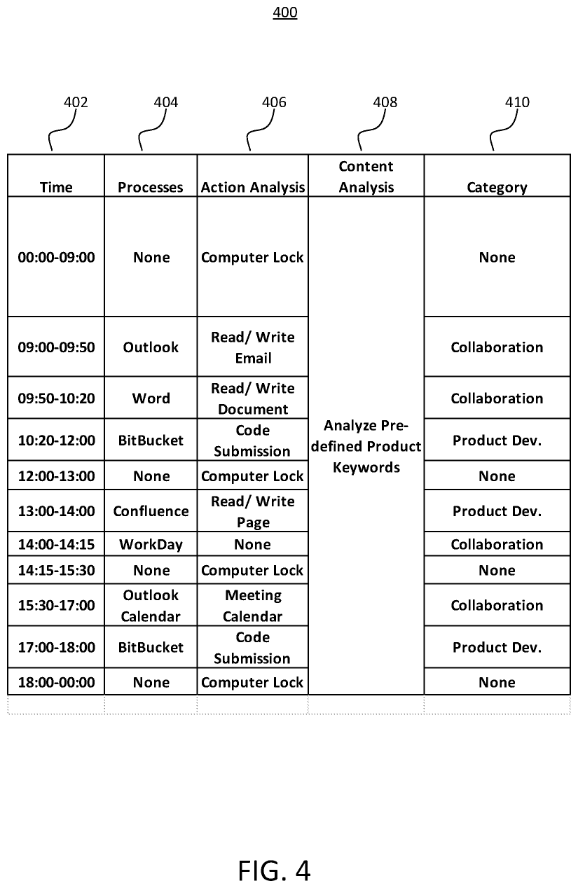

The classifier 206 can utilize the classification depicted in FIG. 4. FIG. 4 depicts an example multi-level classification table 400 illustrating categorization of computing processes by the classifier 206, in accordance with an implementation of this technical solution. The classifier 206 can categorize or classify processes that are executing on a client device into categories 410 using one or more levels of classification. The levels can vary from one another based on the types of classification techniques or the amount of data used by the classification techniques. The classification levels can increase with regard to granularity or resolution, as well the computing resource utilization or data utilization. For example, a first level of classification can utilize the least data input and the least amount of processor or memory utilization, while the highest level of classification can utilize the most data input and the greatest amount of processor and memory utilization. The levels of classification can include, for example, a first level, a second level and a third level. The first level of classification can correspond to processes 404. The second level of classification can correspond to action analysis 406. The third level of classification can correspond to content analysis 408.

The multi-level classification table 400 depicted in FIG. 4 can include a time column 402, a processes column 404, an action analysis column 406, a content analysis column 408, and a category column 410. The classifier 206 can determine values in the time column 402 in any units of time, such as seconds, minutes, hours, days, or years. The time values can be in a local time zone (e.g., corresponding to a geographic location of the user or client device or computing device), centralized time zone or any other time zone. The time values can be in any level of granularity or resolution. The time values include time interval, ranges, time windows, start and stop times, or other time indications corresponding to processes that are executing on the client device. The time values can correspond to the execution of a process.

The classifier 206 can determine processes 230 executed by the client device 226, as indicated in the processes column 404 of table 400. The processes column 404 can indicate a process 230 (e.g., application, engineering tool, or other task executed by the client device). A process 230 can refer to application being executed by the client device in a foreground process or task. The classifier 206 can determine a start and stop time for the execution of the processes 230. The classifier 206 can determine the start time and stop time for the execution of the processes 230 based on time stamps that are included for the processes 230 in the data received from the agent 232. For example, the received data can include a start time stamp for a process and a start time stamp for the process. In another example, the received data can include a start time stamp and a time duration for the process. The classifier 206 can also determine a time window for the execution of the processes based on the time stamps or time durations provided in the data received from the agent 232. The classifier 206 can determine a start and stop time, or time window, in which the processes are executing as part of a foreground process.

In a first level of classification, the classifier 206 can determine the category 410 based on the processes column 404. For example, the classifier 206 can determine that the category is one of none, collaboration, or product development for a time in the time column 402 based on a process in the processes column 404. The classifier 206 can be configured with a mapping or index of processes to categories, and perform a lookup in the map or index to determine the category, as indicated in the categories column 410, based on a process in the processes column 404. Thus, in a first level of classification, the system can use data input such as time values in time column 402 and process identifiers in processes column 404, to determine the categories in the category column 410. The classifier 206 can perform the first level of classification without using information or inputs of the action analysis column 406 or content analysis column 408. In some cases, level one classification may not be customizable by a company or employer of the user.

In a second level of classification, the classifier 206 can perform action analysis 406. Action analysis 406 can include determining an action performed via a process. The action can refer to an action performed by the process, or an action performed by a user of the process. Action analysis 406 can refer to a level of classification that is more granular than process analysis (e.g., the first level of classification). To perform action analysis 406, the classifier 206 can analyze, process or otherwise use more data relative to the first level of classification based on the processes depicted in processes column 404. The classifier 206, performing level two classification, can determine a state of a process, analyze input/output of the process, determine a time window of the process, or use other information of the processes. Action analysis can refer to an action being performed by the process. Action analysis 406 can refer to or include the system analyzing the processes to determine a corresponding action. The classifier 206 can use various action analysis techniques to determine an action, and indicate the action in an action analysis column 406 as depicted in table 400. Action analysis may not take into account content of the process. For example, action analysis can determine whether an e-mail is being written, read, or sent, but not include parsing the text of the email. Level two classification, which is more detailed than level one classification by performing the action analysis to obtain more detailed data, can be customized by the employer or software company. For example, the employer can provide predetermined or predefined action categories.

The classifier 206 can perform level three classification, which is more detailed and granular than level of one and level two, by performing content analysis. Content analysis, as depicted in content analysis column 408 of table 400, can refer to determine exact actions in a manner that is more granular or precise than action analysis. Content analysis can include, for example, determining keywords of the content of the process. For example, in level one classification, the system can determine that Outlook is being used. In level two classification, the classifier 206 can determine that an e-mail is being written using Outlook. In level three classification, the system can determine that content of the e-mail is about scheduling a meeting. Thus, level three classification can utilize information such as text of the e-mail to perform a more detailed analysis of the process relative to levels one and two.

Level three classification can be customized by an entity (e.g., the company or employer associated with the user or client device 226). For example, an employer can provide keywords (e.g., predefined keywords) for content analysis, as well as a mapping of the keyword to a category. The classifier 206 can use a machine learning engine or model to perform content analysis.

The classifier 206 can be configured to perform more than three levels of classifications, or the levels of classification can correspond to different types of classifications. For example, the classifier 206 can be configured to perform a fourth classification (or a fourth level of classification) that includes a more detailed content analysis, such as a semantic analysis or natural language processing, to determine a category. Categories output via the fourth classification can be more granular relative to categories output via the lower levels of classification. For example, the categories output by the fourth classification can correspond to specific projects the company is working on, or specific stages in a product development cycle. Thus, different organizations, companies, or entities can configure different levels of classification based on the level of accuracy, amount of data input, or computing resource utilization they desire, and the classifier 206 can execute the corresponding classification.

For example, the set of inputs can include the type of the application and a type of activity. The ROS 202 can determine a value for the type of the application as one of a source code version control system or a communication tool. The ROS 202 can detect, in the received data, a value for the type of activity as one of coding or collaboration. The ROS 202 can determine the category as one of product development or a collaboration effort. For example, if the type of the application is a source code version control system, then the ROS 202 can determine that the activity is coding, and the category is product development. If the type of the application is a communication tool (e.g., a direct messaging tool), then the ROS 202 can determine that the type of activity is collaboration, then the ROS 202 can determine that the category is collaboration effort.

The ROS 202 can include a validator 208 designed, constructed and operational to validate an output of the classifier 206. The validator 208 can include software or instructions executed by a hardware processor. Validating an output can refer to or include determining an accuracy or level of confidence associated with an output of the classifier 206, as described in more detail below. The validator 208 can determine a confidence score of a category output by the classifier 206. The validator 208 can use one or more techniques to determine a confidence score of a category output by the classifier 206. The validator 208 can determine the confidence score based on combining multiple confidence scores output by different techniques in order to obtain a more accurate representation of the level of confidence. The overall confidence score can be an average of multiple individual confidence scores using different techniques. If one technique outputs a low confidence score, but three other techniques input a high confidence score, then the overall confidence score can be medium-to-high, which may represent a more accurate level of confidence. However, if only one technique was used and the output was a low confidence score, then the validator 208 may incorrectly indicate that the output of the classifier 206 is inaccurate.

The validator 208 can determine a confidence level or score of the category output by the classifier 206 based on the amount of time the classifier 206 or ROS 202 has been categorizing data for the client device ID 220 or the entity ID 224. The validator 208 can determine a confidence level or score based on the amount of data received for the client device ID, or for an entity ID. For example, if the ROS 202 has been categorizing data for the entity ID for only one week, then the validator 208 can assign a confidence level of “low” to the categories output by the classifier 206 in the first week. If the ROS 202 has been categorizing data for the entity ID or user ID for more than one week, but less than 4 weeks, then the validator 208 can assign a confidence level of “medium” to categories output by the classifier 206 for weeks two and three, for example. If the ROS 202 has been categorizing data for the entity ID or user ID for four weeks or more, then the validator can assign a confidence level of “high” to those categories output by the classifier 206. In some cases, the validator 208 can similarly assign the confidence level based on the amount of time the classifier 206 has been categorizing data associated with a particular process 130 (e.g., type of application). The validator 208 can similarly assign the confidence level based on the amount of time the classifier 206 has been categorizing data using a particular type of classification. Thus, the validator 208 can assign a confidence level based on the amount of time the classifier 206 has been categorizing data for the user ID, for an entity ID, for a type of process 130, using a type of classification, or other criteria. The confidence level can be low initially, as the validator 208 may determine that an initial categorization period can correspond to a learning phase for the classifier 206, whereas a later categorization period can correspond to a trained phase.

The validator 208 can assign a confidence level based on the amount of data that has been received from the agent 232 for a particular time period or process 130. If the amount of data that is received is below a threshold, the validator 208 can assign confidence of “low” to a corresponding category output by the classifier 206 using this received data. If the amount of data that is received is above a threshold, the validator 208 can assign confidence of “high” to a corresponding category output by the classifier 206 using this received data. The amount of data can refer to, for example, file size of data or type of data. File size of data can be measured in bytes or megabytes, and the threshold can correspond to a number of megabytes worth of data per time period of data. For example, the validator 208 can assign a confidence level of low if the amount of data received to categorize 1 week of processes executing on a client device is below a threshold, such as 1 megabyte, 2 megabytes, 3 megabytes, 5 megabytes or other threshold determined or set by the ROS 202 or an administrator.

The validator 208 can assign a confidence level based on the type of data. For example, if the received data includes screen capture data of visual output or a graphical user interface of processes 130 executed by the client device 226, then the validator 208 can assign a high confidence level to categories output by the classifier 206 using the screen capture data. The validator 208 can assign a level of confidence based on the amount of screen capture data. For example, if the agent 232 provides screen capture for every minute during a time period, and the classifier 206 categorized the data for that time period based at least in part on the screen captures, then the validator 208 can assign a confidence level of high for those categories output by the classifier 206.

The validator 208 can determine a confidence level of score based on the number of inputs used by the classifier 206 to determine a category. The confidence level or score can be based on the number of total inputs in the set of inputs for the selected classification. The confidence level of score can be based on the whether values exist in the received data for all of the inputs in the set of inputs. For example, if the set of inputs consists of six parameters, but the received data only includes values for three of the parameters and is missing values for the remaining three parameters, then the validator 208 can assign a low confidence for the categories output by the classifier 206 using the partial set of inputs.

If the classification type corresponds to a machine learning model, then the validator 208 can assign a confidence level based on the training of the model. The validator 208 can assign the confidence based on the amount of historical data used to train the model. In some cases, a confidence score may be an output of the machine learning model. For example, the classifier 206 can provide a confidence score for the category output by the machine learning model. The machine learning model can be trained based on historical received data and corresponding categories, that can be referred to as ground truth data. The historical data can include process IDs, application states, processor utilization, keywords, text, input/output, or other data that can be used by the classifier 206 to determine categories. The historical data can also include categories of the received data that the machine learning engine can use to train a machine learning model. For example, during a training phase, the classifier 206 can provide a prompt for a user to input categories associated with the received data. The classifier 206 can utilize the user input to train a machine learning model.

Thus, the ROS 202 can use a machine learning model to determine the category for the given time interval. The ROS 202 can provide a prompt to a user of the client device 226 to indicate whether the category for the given time interval is accurate. The ROS 202 can receive, responsive to the prompt, an indication as to whether the category determined for the given time interval via the machine learning model is accurate. The ROS 202 can update the machine learning model based on the received indication.

The validator 208 can determine a confidence level of score of the category output by the classifier 206. If the confidence level is low or below a threshold (e.g., less than or equal to a threshold of 0.5), then the validator 208 can generate and provide a prompt that requests a user of the client device 226 to confirm that the category output by the classifier 206 is correct. If the confidence level is high or greater than or equal to a threshold (e.g., 0.5), then the validator 208 can determine not to provide a prompt with a request to confirm the category. In some cases, the validator 208 may determine when to provide the prompt based on the confidence level. For example, if the confidence level is low, then the validator 208 can provide the prompt in real-time or at the end of a first time interval (e.g., 8 business hours or daily). If the confidence level is medium, then the validator 208 can provide the prompt at the end of a second time interval (e.g., 40 business hours or weekly). If the confidence level is high, then the validator 208 can provide the prompt at the end of a third time interval which can be longer than the first and second time intervals, such as monthly or the end of 160 business hours.

The validator 208, upon receiving input responsive to the prompt, can confirm the category output by the classifier 206, or modify the category to an updated category. The validator 208 can store the confirmed or updated category in data repository 234. The validator 208 can provide the confirmed or updated category to the classifier 206 to cause the classifier 206 to update the classification or machine learning model so as to improve the categorization in the future. Thus, the validator 208 can identify a confidence level of the determination of the category for a given time interval using the classification. For example, the validator 208 can determine the confidence level based on an amount of data collected for the client device. The validator 208 can determine, based on a comparison between the confidence level and a threshold, to provide a prompt for input to confirm the category for the given time interval is accurate.

The ROS 202 can include a resource allocator 210 designed, constructed and operational to provide one or more micro applications (“microapps”) to the client device based at least in part on the determined category. The resource allocator 210 can adjust one or more types of resources, allocate resources, or otherwise manage resources based on the categories determined by the classifier 206 based on the received data. Resources can refer to or include microapps, such as those microapps provided by microapp service 530 depicted in FIG. 5C, SaaS applications 510 depicted in FIGS. 5A and 5B, resource feeds 506 depicted in FIGS. 5A and 5B, or other types of applications or processes 130. The microapps, or identifiers of the microapps, can be stored in a micro apps data structure 222 in data repository 234. The micro apps data structure 222 can include information about micro apps installed on a client device 226, or micro apps that are accessible to (or executable on) a client device 226. In some cases, resources can include client devices 228, client device 226, types of client devices 226, or employees (e.g., users or personnel). In some cases, resources can refer to or include time management or time allocation.

The resource allocator 210 can automatically allocate resources based on categories output by the classifier 206. The resource allocator 210 can provide a notification indicating a suggested or recommended resource allocation. An administrator of the ROS 202 or entity can receive the notification and determine to adjust the resource allocation in accordance with the notification. The resource allocator 210 can cause the ROS 202 to adjust resource allocation, or cause a cloud computing environment 514 to adjust resource allocation, for example.

The resource allocator 210 can obtain categories determined by the classifier 206 for a client device, an entity, or a group of client devices associated with an entity. The resource allocator 210 can receive one or more reports for one or more time intervals. The resource allocator 210 can analyze or process the reports to determine a resource allocation. The resource allocator 210 can use one or more load balancing or load optimization techniques to determine the resource allocation.

For example, the resource allocator 210 can determine that a percentage of time is spent collaborating using in-person meetings. The resource allocator 210 can determine that this “collaboration” category (e.g., as indicated in category column 410 of FIG. 4) by way of in-person meetings (e.g., as indicated via the action analysis column 406 depicted in FIG. 4) may detract from other types of activities corresponding to other categories such as the Product Development category depicted in the category column 410 of FIG. 4. The resource allocator 210, therefore, may provide an indication to reduce the number of calendar meetings for a given time interval in order to increase the amount of time spent developing a product.

In another example, the resource allocator 210 can determine to provide a virtual meeting microapp to allow the user to conduct the meeting virtually, as opposed to attending the meeting in-person. The resource allocator 210 can suggest a virtual meeting microapp. The resource allocator 210 can suggest the virtual meeting microapp responsive to determining that the amount of time collaborating is greater than a threshold amount of time.

In some cases, the resource allocator 210 can determine to remove a microapp or application, uninstall a microapp, block use of the microapp, or otherwise limit use of a microapp. For example, the resource allocator 210 can determine that a significant amount of time is spent collaborating via a messaging application. The resource allocator 210 can determine that this collaborating via a messaging application does not correspond to any specific project or product using a level three classification that can analyze keywords of the content input via the messaging app. The resource allocator 210 can determine that this time may be better spent developing the product, for example. Thus, the resource allocator 210 can block or limit use of the messaging application, thereby reducing computer network usage or wasted resources, while increasing product development.

In another example, the resource allocator 210 can indicate that a large amount of time is spent developing the product, and that additional team members may facilitate spreading the product development. For example, if a manger is spending significant time writing code, as opposed to managing, then the resource allocator 210 can determine that additional software engineers should be added to the team in order to improve load balancing and delegation of software development.

The ROS 202 can include a report generator 212 designed, constructed and operational to provide a graphical user interface that includes output of the classifier 206, such as categories determine by the classifier 206 using a classification and received data. The report generator 212 can generate dynamic or static reports. The report generator 212 can generate reports in real-time, or based on a batch upload of data or processing. The report generator 212 can generate reports responsive to a request, based on a time interval, or based on a condition or event. The report generator 212 can generate notifications based on categories or other triggers. The report generator 212 can provide the report for presentation via a client device 226. The report generator 212 can provide reports to an administrator or manager of an entity that includes information about other users at the entity. The report generator 212 can provide reports to authorized users.

The report generator 212 can receive input via a dynamic or interactive report. An example of a report generated by the report generator 212 is depicted in FIG. 4. As illustrated in FIG. 4, the report generator 212 can provide information about time intervals 402, processes 404, action analysis 406, content analysis 408, and output categories 410. In some cases, the report generator 410 can further indicate a confidence level of one or more of 404, 406, 408 or 410. For example, the report generator 212 can receive the confidence level of individual categories in the category column, and provide an indication of the confidence level via the report. The report generator 212 can provide the confidence level using various techniques. The report generator 212 can indicate the confidence level alongside the category in column 410. The report generator 212 can generate an additional column for the confidence level. The report generator 212 can color code the categories to indicate a confidence level of the category (e.g., green can indicate high confidence, yellow can indicate medium confidence, and red can indicate low confidence). The report generator 212 can provide a prompt (e.g., a user interface element, button, drop-down, window, input text box, etc.) to the user to request that the user confirm or validate the category.

Thus, the report generator 212 can generate an interactive report that includes the category for the given time interval. The report generator 212 can receive an indication from the client device 226 that the category for the given time interval is accurate. The report generator 212 can provide the indication to the resource allocator 210. The resource allocator 210 can then select a resource (e.g., one or more microapps) to provide based on the indication.

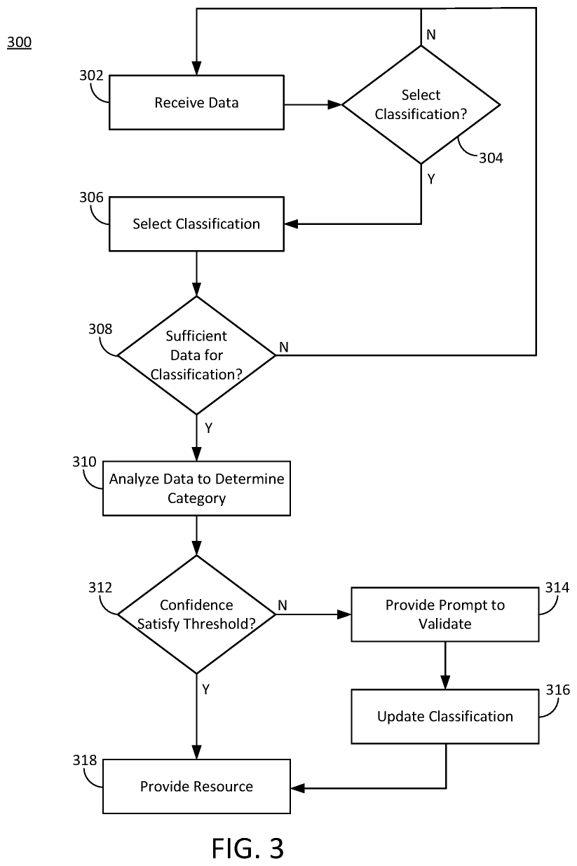

FIG. 3 depicts an example flow diagram of a method for categorizing computing processes, in accordance with an implementation. The method 300 can be performed by one or more system or component depicted in FIGS. 1A, 1B, 2, 5A, 5B, and 5C, including, for example, a server, a resource optimization system and an agent. In brief overview of method 300, a server can receive data at ACT 302. At decision block 304, the server can determine whether to select a classification. At ACT 306, the server can select a classification. At decision block 308, the server can determine whether there is sufficient data to perform the classification. At ACT 310, the server can analyze data to determine a category. At decision block 312, the server can determine whether the confidence satisfies a threshold. If the confidence does not satisfy the threshold, the server can proceed to ACT 314 to provide a prompt to validate the category. The server can proceed to ACT 316 to update a classification. If, at decision block 312, the server determines the confidence satisfies the threshold, the server can proceed to ACT 318 to provide a resource.

Still referring to FIG. 3, and in further detail, the server can receive data at ACT 302. The server can receive data about one or more processes that are executing, or have been executed, or are executable by a native or virtual computing environment provided by a client device. The server can receive the data from an agent, daemon, SaaS application, or plug-in running on the client device (e.g., via the native computing environment or virtual computing environment hosted in a cloud server). The server can receive the data in real-time from the agent (e.g., when the agent collects the data), or in a batch transmission. For example, the agent can capture the data about the processes in real-time or based on a time interval. The agent can store the data in local storage or memory of the client device. The agent can aggregate the captured data, and transmit the data to the server. For example, the agent can transmit the data server based on a time interval (e.g., hourly, every 12 hours, daily, or weekly), responsive to an event (e.g., log-off or log-in), responsive to a request from the server or a user of the client device, or based on a data threshold (e.g., after the amount of data satisfies a data size threshold).

The server can receive the data in any format, and process the data. The data can include data about processes or other data of the processes, such as an identifier of the workstation or user using the workstation, time stamps of the processes, location of the client device, or type of client device.

At decision block 304, the server can determine whether to select a classification. The server can determine whether to select a classification to categorize the received data based on whether the server has received sufficient data or the correct data. For example, the data may be corrupt or missing information, in which case the server may determine that there is insufficient data to categorize the data with sufficient confidence to reliably perform resource allocation. Thus, the server can determine not to select a classification and return to the receive data ACT 302 in order to receive additional data. The server can determine there is sufficient data if there is data for a predetermined time interval (e.g., 9 AM to 5 PM), or if there is data corresponding to the set of inputs (e.g., application identifier or process identifier, time stamps, or usage information), for example.

The server can determine, at decision block 304, to select a classification if the server received sufficient data to select a classification or reliably perform categorization. For example, if the server received a unique identifier associated with the client device, then the server can determine that a classification can be selected based on the unique identifier. In another example, if the server received sufficient data, such as information about a type of process, then the server can determine to select a classification and proceed to ACT 306.

At ACT 306, the server can select a classification. The server can select the classification based on the unique identifier associated with the client device. The server can determine an entity associated with the client device based on the unique identifier by performing a lookup or query in a database. The server can further determine what type of classification has been established for the entity, and select that classification. For example, an administrator of the entity may have established a classification to be used to categorize data about processes executed on client devices of the entity. In some cases, the server can use a classification selection policy to select a classification to use based on one or more criteria associated with the client device or user thereof, such as role of the user, time of day, type of client device, etc.

For example, the server can identify a classification hierarchy established by an organizational entity, such as a company. The organizational entity can be associated with an entity identifier. The classification hierarchy can include multiple levels of classification. Different levels of classification can include multiple categories. The categories can be the same or different at each level. The categories can be more precise or detailed for high classification levels. For example, the classification hierarchy can include a first classification of types of applications being executed. An example of a first classification is depicted in processes column 404 in which the server can obtain the received data, such as application name, and determine a type of application based on the application name. For example, the application name can be “Outlook” and the server can determine that the type of application is a communication tool.

A second classification can correspond to action analysis, and is depicted in the action analysis column 406 of FIG. 4. Action analysis can include determining a type of action being performed on the client device by the process. A third classification can correspond to content analysis, and is depicted in content analysis column 408 of FIG. 4. Content analysis can be based on pre-defined keywords established by an entity. The entity can provide a configuration file that instructs the server to use a particular classification to categorize data of the client device. For example, the entity associated with the client device can indicate to use the third classification to analyze the received data.

At decision block 308, the server can determine whether there is sufficient data to perform the classification. The server, responsive to determining the type of classification to use, can determine whether the received data contains sufficient information to perform the type of classification. The server can determine what the set of inputs for the type of classification, and can determine whether the received data contains values for the set of inputs. If the server determines that sufficient data has been received to perform the selected classification, then the server can proceed to ACT 310 to analyze the data using the selected classification to determine the category. If, however, the server determines that the received data is insufficient to perform the selected classification, then the server can return to ACT 302 to receive additional data. In some cases, the server can determine to use a different classification and proceed with determining a category. For example, the server can determine that while there is insufficient data to perform a level three classification, that there may be sufficient data to perform a level one or level two classification. Accordingly, the server can determine to reduce the classification level to one that uses less data or fewer sets of inputs, and then automatically select the level of classification that corresponds to the received data. The server can then proceed to ACT 310 to analyze the data using the selected classification.

At ACT 310, the server can analyze data to determine a category. The server can analyze the received data for a particular time interval to determine a category based on the selected classification and set of inputs. The server can analyze the data for one or more time intervals of the received data. For example, responsive to determining to use the third classification, the server can select the set of inputs for action analysis and content analysis using the keywords. The server can parse or process the received data to identify a set inputs used by a classifier to perform the third classification. The server can parse the received data, which can include a foreground graphical user interface of an application executable by the client device, to identify the set of inputs used for the third classification. The set of inputs can include name or type of application, state of the application (e.g., read/write email), and keywords of the application, such as keywords or text in the body of an email message.

The server can determine a confidence level or score of the determined category. The server can determine the confidence level based on various factors, including, for example, the phase of a machine learning model, amount of data available, historical use of the classifier, or output of the classifier.

At decision block 312, the server can determine whether the confidence satisfies a threshold. If the confidence level or score does not satisfy a threshold, then the server can perform a validation process. The confidence level or score can satisfy a threshold if the confidence level or score is greater than or equal to a threshold. The confidence level or score may not satisfy a threshold if the confidence level or score is less than or equal to a threshold. For example, the threshold confidence level can be high. If the server determines the confidence level is low or medium, then the server can determine, at decision block 312, to perform a validation process and proceed to ACT 314. If, however, the server determines the confidence level is high at decision block 312, the server can proceed to ACT 318 to provide a resource.

If the confidence does not satisfy the threshold, the server can proceed from decision block 312 to ACT 314 to provide a prompt to validate the category. The server can provide a prompt to a user of the client device from which the data was received. The server can provide the prompt with a request to confirm whether the category is accurate. The server can provide prompts for all categories for multiple time intervals, or only certain categories having confidence levels or scores that do not satisfy the confidence threshold.

At ACT 316, the server can update a classification. Updating a classification can refer to or include changing the category based on the response to the prompt. Updating a classification can include updating a machine learning model based on the response to the prompt. Updating the classification can include validating the category if the response to the prompt confirms that the category determined by the server is correct.

After updating the classification at ACT 316, or determining that the confidence satisfies the threshold at decision block 312, the server can proceed to provide a resource at ACT 318. The server can provide, for example, one or more microapps to the client device based on the determined category. For example, if the determined category includes product development for greater than 80% of the work day, then the server can provide a microapp that facilitates product development or facilitates making product development more efficient. In another example, if the category indicates that the user spends more than a significant percentage of the day in calendar meetings, then the server can select a microapp that facilitates virtual meetings or facilitates reducing the amount of meetings. In another example, if the categories indicate that the client device performs significant processor intensive tasks, then the server can provide additional processor or memory capabilities to the client device, such as additional virtual machines in a cloud infrastructure.

The server can provide resources based on analyzing categories determined for multiple client devices. For example, the server can obtain reports containing categories for processes executed by multiple client devices associated with multiple unique user identifiers that are associated with a same entity. The server can analyze multiple categories of multiple time intervals and multiple client devices associated. The server can determine to adjust, based on the aggregated categories for a second time interval of the multiple time intervals, resource allocation for a group of unique identifiers to improve productivity. For example, when a new user joins the entity or team, the server can determine to assign the new user to perform product development or work on a particular product or phase in a project. In another example, the server can select a certain microapp to provide to a client device. The server, responsive to a new user joining the entity, can configure a client device for the new user with a microapp selected based on the analysis of the categories.

FIG. 5A is a block diagram of an example system 500 in which one or more resource management services 502 may manage and streamline access by one or more clients 226 to one or more resource feeds 506 (via one or more gateway services 508) and/or one or more software-as-a-service (SaaS) applications 510. In particular, the resource management service(s) 502 may employ an identity provider 512 to authenticate the identity of a user of a client 226 and, following authentication, identify one of more resources the user is authorized to access. In response to the user selecting one of the identified resources, the resource management service(s) 502 may send appropriate access credentials to the requesting client 226, and the client 226 may then use those credentials to access the selected resource. For the resource feed(s) 506, the client 226 may use the supplied credentials to access the selected resource via a gateway service 508. For the SaaS application(s) 510, the client 226 may use the credentials to access the selected application directly.

The client(s) 226 may be any type of computing devices capable of accessing the resource feed(s) 506 and/or the SaaS application(s) 510, and may, for example, include a variety of desktop or laptop computers, smartphones, tablets, etc. The resource feed(s) 506 may include any of numerous resource types and may be provided from any of numerous locations. In some embodiments, for example, the resource feed(s) 506 may include one or more systems or services for providing virtual applications and/or desktops to the client(s) 226, one or more file repositories and/or file sharing systems, one or more secure browser services, one or more access control services for the SaaS applications 510, one or more management services for local applications on the client(s) 226, one or more internet enabled devices or sensors, etc. Each of the resource management service(s) 502, the resource feed(s) 506, the gateway service(s) 508, the SaaS application(s) 510, and the identity provider 512 may be located within an on-premises data center of an organization for which the system 500 is deployed, within one or more cloud computing environments, or elsewhere.

FIG. 5B is a block diagram showing an example implementation of the system 500 shown in FIG. 5A in which various resource management services 502 as well as a gateway service 508 are located within a cloud computing environment 514. The cloud computing environment may, for example, include Microsoft Azure Cloud, Amazon Web Services, Google Cloud, or IBM Cloud.

For any of illustrated components (other than the client 226) that are not based within the cloud computing environment 514, cloud connectors (not shown in FIG. 5B) may be used to interface those components with the cloud computing environment 514. Such cloud connectors may, for example, run on Windows Server instances hosted in resource locations and may create a reverse proxy to route traffic between the site(s) and the cloud computing environment 514. In the illustrated example, the cloud-based resource management services 502 include a client interface service 516, an identity service 518, a resource feed service 520, and a single sign-on service 522. As shown, in some embodiments, the client 226 may use a resource access application 524 to communicate with the client interface service 516 as well as to present a user interface on the client 226 that a user 526 can operate to access the resource feed(s) 506 and/or the SaaS application(s) 510. The resource access application 524 may either be installed on the client 226, or may be executed by the client interface service 516 (or elsewhere in the system 500) and accessed using a web browser (not shown in FIG. 5B) on the client 226.

As explained in more detail below, in some embodiments, the resource access application 524 and associated components may provide the user 526 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 524 is launched or otherwise accessed by the user 526, the client interface service 516 may send a sign-on request to the identity service 518. In some embodiments, the identity provider 512 may be located on the premises of the organization for which the system 500 is deployed. The identity provider 512 may, for example, correspond to an on-premises Windows Active Directory. In such embodiments, the identity provider 512 may be connected to the cloud-based identity service 518 using a cloud connector (not shown in FIG. 5B), as described above. Upon receiving a sign-on request, the identity service 518 may cause the resource access application 524 (via the client interface service 516) to prompt the user 526 for the user's authentication credentials (e.g., user-name and password). Upon receiving the user's authentication credentials, the client interface service 516 may pass the credentials along to the identity service 518, and the identity service 518 may, in turn, forward them to the identity provider 512 for authentication, for example, by comparing them against an Active Directory domain. Once the identity service 518 receives confirmation from the identity provider 512 that the user's identity has been properly authenticated, the client interface service 516 may send a request to the resource feed service 520 for a list of subscribed resources for the user 526.

In other embodiments (not illustrated in FIG. 5B), the identity provider 512 may be a cloud-based identity service, such as a Microsoft Azure Active Directory. In such embodiments, upon receiving a sign-on request from the client interface service 516, the identity service 518 may, via the client interface service 516, cause the client 226 to be redirected to the cloud-based identity service to complete an authentication process. The cloud-based identity service may then cause the client 226 to prompt the user 526 to enter the user's authentication credentials. Upon determining the user's identity has been properly authenticated, the cloud-based identity service may send a message to the resource access application 524 indicating the authentication attempt was successful, and the resource access application 524 may then inform the client interface service 516 of the successfully authentication. Once the identity service 518 receives confirmation from the client interface service 516 that the user's identity has been properly authenticated, the client interface service 516 may send a request to the resource feed service 520 for a list of subscribed resources for the user 526.

For each configured resource feed, the resource feed service 520 may request an identity token from the single sign-on service 522. The resource feed service 520 may then pass the feed-specific identity tokens it receives to the points of authentication for the respective resource feeds 506. Each resource feed 506 may then respond with a list of resources configured for the respective identity. The resource feed service 520 may then aggregate all items from the different feeds and forward them to the client interface service 516, which may cause the resource access application 524 to present a list of available resources on a user interface of the client 226. The list of available resources may, for example, be presented on the user interface of the client 226 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 226, and/or one or more SaaS applications 510 to which the user 526 has subscribed. The lists of local applications and the SaaS applications 510 may, for example, be supplied by resource feeds 506 for respective services that manage which such applications are to be made available to the user 526 via the resource access application 524. Examples of SaaS applications 510 that may be managed and accessed as described herein include Microsoft Office 365 applications, SAP SaaS applications, Workday applications, etc.

For resources other than local applications and the SaaS application(s) 510, upon the user 526 selecting one of the listed available resources, the resource access application 524 may cause the client interface service 516 to forward a request for the specified resource to the resource feed service 520. In response to receiving such a request, the resource feed service 520 may request an identity token for the corresponding feed from the single sign-on service 522. The resource feed service 520 may then pass the identity token received from the single sign-on service 522 to the client interface service 516 where a launch ticket for the resource may be generated and sent to the resource access application 524. Upon receiving the launch ticket, the resource access application 524 may initiate a secure session to the gateway service 508 and present the launch ticket. When the gateway service 508 is presented with the launch ticket, it may initiate a secure session to the appropriate resource feed and present the identity token to that feed to seamlessly authenticate the user 526. Once the session initializes, the client 226 may proceed to access the selected resource.

When the user 526 selects a local application, the resource access application 524 may cause the selected local application to launch on the client 226. When the user 526 selects a SaaS application 510, the resource access application 524 may cause the client interface service 516 request a one-time uniform resource locator (URL) from the gateway service 508 as well a preferred browser for use in accessing the SaaS application 510. After the gateway service 508 returns the one-time URL and identifies the preferred browser, the client interface service 516 may pass that information along to the resource access application 524. The client 226 may then launch the identified browser and initiate a connection to the gateway service 508. The gateway service 508 may then request an assertion from the single sign-on service 522. Upon receiving the assertion, the gateway service 508 may cause the identified browser on the client 226 to be redirected to the logon page for identified SaaS application 510 and present the assertion. The SaaS may then contact the gateway service 508 to validate the assertion and authenticate the user 526. Once the user has been authenticated, communication may occur directly between the identified browser and the selected SaaS application 510, thus allowing the user 526 to use the client 226 to access the selected SaaS application 510.

In some embodiments, the preferred browser identified by the gateway service 508 may be a specialized browser embedded in the resource access application 524 (when the resource application is installed on the client 226) or provided by one of the resource feeds 506 (when the resource application 524 is located remotely), e.g., via a secure browser service. In such embodiments, the SaaS applications 510 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 226 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 506) for assessment of its security risk by a web filtering service. For approved URLs, the specialized browser may be permitted to access the link. For suspicious links, however, the web filtering service may have the client interface service 516 send the link to a secure browser service, which may start a new virtual browser session with the client 226, and thus allow the user to access the potentially harmful linked content in a safe environment.

In some embodiments, in addition to or in lieu of providing the user 526 with a list of resources that are available to be accessed individually, as described above, the user 526 may instead be permitted to choose to access a streamlined feed of event notifications and/or available actions that may be taken with respect to events that are automatically detected with respect to one or more of the resources. This streamlined resource activity feed, which may be customized for each user 526, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 226 to notify a user 526 of something that requires the user's attention (e.g., approval of an expense report, new course available for registration, etc.).

FIG. 5C is a block diagram similar to that shown in FIG. 5B but in which the available resources (e.g., SaaS applications, web applications, Windows applications, Linux applications, desktops, file repositories and/or file sharing systems, and other data) are represented by a single box 528 labeled “systems of record,” and further in which several different services are included within the resource management services block 502. As explained below, the services shown in FIG. 5C may enable the provision of a streamlined resource activity feed and/or notification process for a client 226. In the example shown, in addition to the client interface service 516 discussed above, the illustrated services include a microapp service 530, a data integration provider service 532, a credential wallet service 534, an active data cache service 536, an analytics service 538, and a notification service 540. In various embodiments, the services shown in FIG. 5C may be employed either in addition to or instead of the different services shown in FIG. 5B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 524 without having to launch the native application. The system shown in FIG. 5C may, for example, aggregate relevant notifications, tasks, and insights, and thereby give the user 526 a dynamic productivity tool. In some embodiments, the resource activity feed may be intelligently populated by utilizing machine learning and artificial intelligence (AI) algorithms. Further, in some implementations, microapps may be configured within the cloud computing environment 514, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 5C, the systems of record 528 may represent the applications and/or other resources the resource management services 502 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 502, and in particular the data integration provider service 532, may, for example, support REST API, JSON, OData-JSON, and 6ML. As explained in more detail below, the data integration provider service 532 may also write back to the systems of record, for example, using OAuth2 or a service account.

In some embodiments, the microapp service 530 may be a single-tenant service responsible for creating the microapps. The microapp service 530 may send raw events, pulled from the systems of record 528, to the analytics service 538 for processing. The microapp service may, for example, periodically pull active data from the systems of record 528.

In some embodiments, the active data cache service 536 may be single-tenant and may store all configuration information and microapp data. It may, for example, utilize a per-tenant database encryption key and per-tenant database credentials.

In some embodiments, the credential wallet service 534 may store encrypted service credentials for the systems of record 528 and user OAuth2 tokens.

In some embodiments, the data integration provider service 532 may interact with the systems of record 528 to decrypt end-user credentials and write back actions to the systems of record 528 under the identity of the end-user. The write-back actions may, for example, utilize a user's actual account to ensure all actions performed are compliant with data policies of the application or other resource being interacted with.

In some embodiments, the analytics service 538 may process the raw events received from the microapps service 530 to create targeted scored notifications and send such notifications to the notification service 540.

Finally, in some embodiments, the notification service 540 may process any notifications it receives from the analytics service 538. In some implementations, the notification service 540 may store the notifications in a database to be later served in a notification feed. In other embodiments, the notification service 540 may additionally or alternatively send the notifications out immediately to the client 226 as a push notification to the user 526.

In some embodiments, a process for synchronizing with the systems of record 528 and generating notifications may operate as follows. The microapp service 530 may retrieve encrypted service account credentials for the systems of record 528 from the credential wallet service 534 and request a sync with the data integration provider service 532. The data integration provider service 532 may then decrypt the service account credentials and use those credentials to retrieve data from the systems of record 528. The data integration provider service 532 may then stream the retrieved data to the microapp service 530. The microapp service 530 may store the received systems of record data in the active data cache service 536 and also send raw events to the analytics service 538. The analytics service 538 may create targeted scored notifications and send such notifications to the notification service 540. The notification service 540 may store the notifications in a database to be later served in a notification feed and/or may send the notifications out immediately to the client 226 as a push notification to the user 526.

In some embodiments, a process for processing a user-initiated action via a microapp may operate as follows. The client 226 may receive data from the microapp service 530 (via the client interface service 516) to render information corresponding to the microapp. The microapp service 530 may receive data from the active data cache service 536 to support that rendering. The user 526 may invoke an action from the microapp, causing the resource access application 524 to send that action to the microapp service 530 (via the client interface service 516). The microapp service 530 may then retrieve from the credential wallet service 534 an encrypted Oauth2 token for the system of record for which the action is to be invoked, and may send the action to the data integration provider service 532 together with the encrypted Oath2 token. The data integration provider service 532 may then decrypt the Oath2 token and write the action to the appropriate system of record under the identity of the user 526. The data integration provider service 532 may then read back changed data from the written-to system of record and send that changed data to the microapp service 530. The microapp service 532 may then update the active data cache service 536 with the updated data and cause a message to be sent to the resource access application 524 (via the client interface service 516) notifying the user 526 that the action was successfully completed.

In some embodiments, in addition to or in lieu of the functionality described above, the resource management services 502 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 502 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 502 may, for example, parse these requests and respond because they are integrated with multiple systems on the back-end. In some embodiments, users may be able to interact with the virtual assistance through either the resource access application 524 or directly from another resource, such as Microsoft Teams. This feature may allow employees to work efficiently, stay organized, and deliver only the specific information they're looking for.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

It will be further understood that various changes in the details, materials, and arrangements of the parts that have been described and illustrated herein may be made by those skilled in the art without departing from the scope of the following claims.

What is claimed is:

1. A method, comprising:
receiving, by a server comprising one or more processors, data about one or more processes executable by a client device, the one or more processes being executable within one or more time intervals, and the client device being identifiable with a unique identifier;
selecting, by the server based on the unique identifier, a classification and a set of inputs to use to determine one or more categories for the received data, the set of inputs comprising a type of an application accessible by the client device and information about usage of the application;
analyzing, by the server, the received data for a given time interval to determine a category based on the selected classification and the set of inputs; and
providing, by the server, one or more micro applications to the client device based at least in part on the determined category.

2. The method of claim 1, comprising:
receiving, by the server, the data from an agent executable on the client device, wherein the data includes a screen capture.

3. The method of claim 1, comprising:
receiving, by the server, an indication from the client device that the category for the given time interval is accurate; and
selecting, by the server, the one or more micro applications to provide based on the indication.

4. The method of claim 1, comprising:
identifying a confidence level of the determination of the category for the given time interval using the classification; and
requesting, based on a comparison between the confidence level and a threshold, input to confirm the category for the given time interval is accurate.

5. The method of claim 4, comprising:
determining, by the server, the confidence level based on an amount of data collected for the client device.

6. The method of claim 1, comprising:
providing, by the server, a request for input that indicates the category for the given time interval is accurate;
receiving, by the server responsive to the request, an indication that category determined for the given time interval via the machine learning model is accurate; and
updating, by the server, the category based on the received indication.

7. The method of claim 1, wherein the set of inputs comprise the type of the application and a type of activity, comprising:
determining a value for the type of the application as one of a source code version control system or a communication tool;
detecting a value for the type of activity as one of coding or collaboration; and
determining the category as one of product development or project development.

8. The method of claim 1, comprising:
identifying, by the server, an organizational entity based on the unique identifier of the client device;
retrieving, by the server, a classification hierarchy established by the organizational entity, the classification hierarchy including a plurality of classifications, and at least one classification including a plurality of categories; and
selecting, by the server based on the unique identifier, the classification to use to analyze the received data from the plurality of classifications of the classification hierarchy.

9. The method of claim 1, comprising:
aggregating categories for a second time interval determined for a plurality of unique identifiers indicative of a plurality of client devices; and
adjusting, based on the aggregated categories for the second time interval, resource allocation for a group of unique identifiers comprising the unique identifier to improve productivity.

10. The method of claim 1, comprising:
identifying, by the server, a classification hierarchy established by an organizational entity identifiable with the unique identifier, the classification hierarchy including a plurality of classifications, at least one classification including a plurality of categories, wherein the classification hierarchy comprises a first classification of types of applications executable on the client device, a second classification for action analysis, and a third classification for content analysis based on keywords in the received data;
identifying the classification as the third classification;
selecting the set of inputs for action analysis and content analysis using the keywords; and
parsing the received data comprising a foreground graphical user interface of an application executable by the client device to identify the set of inputs used for the third classification.

11. A system, comprising:
a server comprising one or more processors configured to:
receive data about one or more processes executable by a client device, the one or more processes being executable within one or more time intervals, and the client device being identifiable with a unique identifier;
select, based on the unique identifier, a classification and a set of inputs to use to determine one or more categories for the received data, the set of inputs comprising a type of an application accessible by the client device and information about usage of the application;
analyze the received data for a given time interval to determine a category based on the selected classification and the set of inputs; and
provide one or more micro applications to the client device based at least in part on the determined category.

12. The system of claim 11, wherein the server is further configured to:
receiving, by the server, the data from an agent executable on the client device, wherein the data includes a screen capture.

13. The system of claim 11, wherein the server is further configured to:
receive an indication from the client device that the category for the given time interval is accurate; and
select the one or more micro applications to provide based on the indication.

14. The system of claim 11, wherein the server is further configured to:
identify a confidence level of the determination of the category for the given time interval using the classification; and
request, based on a comparison between the confidence level and a threshold, input to confirm the category for the given time interval is accurate.

15. The system of claim 14, wherein the server is further configured to:
determine the confidence level based on an amount of data collected for the client device.

16. The system of claim 11, wherein the server is further configured to:
provide a request for input that indicates the category for the given time interval is accurate;
receive, responsive to the request, an indication that category determined for the given time interval via the machine learning model is accurate; and
update the category based on the received indication.

17. The system of claim 11, wherein the set of inputs comprise the type of the application and a type of activity, and the server is further configured to:
determine a value for the type of the application as one of a source code version control system or a communication tool;
detect a value for the type of activity as one of coding or collaboration; and
determine the category as one of product development or project development.

18. The system of claim 11, wherein the server is further configured to:
identify an organizational entity based on the unique identifier of the client device;
retrieve a classification hierarchy established by the organizational entity, the classification hierarchy including a plurality of classifications, and at least one classification including a plurality of categories; and
select, based on the unique identifier, the classification to use to analyze the received data from the plurality of classifications of the classification hierarchy.

19. The system of claim 11, wherein the server is further configured to:
aggregate categories for a second time interval determined for a plurality of unique identifiers indicative of a plurality of client devices; and
adjust, based on the aggregated categories for the second time interval, resource allocation for a group of unique identifiers comprising the unique identifier to improve productivity.

20. The system of claim 11, wherein the server is further configured to:
identify a classification hierarchy established by an organizational entity identifiable with the unique identifier, the classification hierarchy including a plurality of classifications, at least one classification including a plurality of categories, wherein the classification hierarchy comprises a first classification of types of applications executable on the client device, a second classification for action analysis, and a third classification for content analysis based on keywords in the received data;
identify the classification as the third classification;
select the set of inputs for action analysis and content analysis using the keywords; and
parse the received data comprising a foreground graphical user interface of an application executable by the client device to identify the set of inputs used for the third classification.
